(19) United States
(12) Patent Application Publication
(10) Pub. No.: US 2005/0265587 A1
(43) Pub. Date: Dec. 1, 2005

(54) Fingerprint image database and method of matching fingerprint sample to fingerprint images

(76) Inventor: John K. Schneider, Snyder, NY (US)

Correspondence Address: HODGSON RUSS LLP, ONE M & T PLAZA, SUITE 2000, BUFFALO, NY, 14203-2391, US

(21) Appl. No.: 11/142,548

(22) Filed: Jun. 1, 2005

Related U.S. Application Data
(60) Provisional application No. 60/575,952, filed on Jun. 1, 2004.

(51) Int. Cl. G06K 9/00

(52) U.S. Cl. 382/124

(57) ABSTRACT

A database of fingerprint images and methods of using such a database are disclosed. The database may have at least two fingerprint images that are impression images produced by a single finger. Each impression image shows a different portion of the friction ridge surface of the finger. Methods using the database may be focused on determining whether a match exists between a fingerprint sample and the database images.

### CROSS-REFERENCE TO RELATED APPLICATION

This application claims the benefit of priority to U.S. provisional patent application Ser. No. 60/575,952, filed on Jun. 1, 2004.

### FIELD OF THE INVENTION

The invention relates to a live-scan fingerprint recording process in which skin surface friction ridge detail information is collected and compared to fingerprint information in a database.

### BACKGROUND OF THE INVENTION

A problem exists in many fingerprint database systems where the stored fingerprint images or the feature extracted representations (herein collectively referred to as “fingerprint images”) are used for comparison with sample fingerprint images submitted for purposes of determining whether the samples match the database images. Frequently, the sample image, although rich in feature detail, fails to be matched with a database image and thereby recognized, because the person that provided the database image did not have the finger properly oriented on the imaging platen during the image capture process. For example, the finger may have been tilted to the side or may have been stood on the extreme end of the finger. The match request fails in these circumstances, not because of lack of detail, but because the sample does not represent the same surface of the finger as that which is stored in the traditional database. A traditional database contains for each hand a rolled impression of each finger, a non-rolled impression of the palm-side of the four fingers taken simultaneously, and a non-rolled impression of the palm-side of the thumb. When used without the modifier “rolled”, the term “impression” is used herein to refer to a non-rolled impression. Therefore, there is a need for a system and method which will properly match a sample fingerprint to an image in a database even though the finger may not have been optimally oriented when it left the sample, or when the stored image was generated, or both.

In addition to the problem of finger orientation or misalignment during the fingerprint collection process, another source of error may come from the use of rolled impression fingerprint images collected by the conventional finger rolling technique. For more than a century fingerprint information has been collected from human fingers and hands by means of ink and paper. The quality of the collected fingerprint relied heavily on the skill and dexterity of the operator collecting the fingerprint. The manual collection of ink-and-paper fingerprints by the method of rolling carried with it the inherent problem of image distortion from the rolling process, and this problem persists in live-scan fingerprint readers that make use of the physical rolling process to collect a fingerprint image. In the process of rolling a finger on a flat surface, the skin and underlying fat and tissue bunch up and accumulate on the trailing edge of the finger and slightly stretch the skin, thus creating a distorted fingerprint image. See FIG. 1. If, at a later time, the rolled impression image is compared to fingerprint samples collected from forensic activity by the lifting of latent images, the latent fingerprint images would not have the distortion within them and comparison with a rolled impression image would sometimes erroneously not yield a match. This same effect is seen when comparing plain impression images to rolled impression images, since the plain impression images lack the distortion. Therefore, there is a need for a system and method which will properly match a fingerprint to an image in a database even though the process used to take the fingerprint image may not have been executed ideally.

### SUMMARY OF THE INVENTION

The present invention may include a database of fingerprint images, wherein at least two of the fingerprint images are impression images produced by a single finger, and each of the impression images shows a different portion of the friction ridge surface of the finger. For example, the impression images may correspond to an end of the finger, a right side of the finger, a left side of the finger, or a palm-side of the finger. The database may also include a rolled impression image corresponding to the finger and/or a computer generated image corresponding to a combination of some or all of the impression images. The images from the same finger may be linked so as to indicate that the images were obtained from the same finger.

Methods according to the invention may utilize such a database. In one such method, a sample fingerprint is provided and compared to each of the impression images. A determination may be made as to whether the sample matches either of the impression images, or both, and an indication may be provided as to whether a match was found with the impression images. Determining whether the sample matches may include determining whether the sample is similar enough to either of the impression images, or both, to constitute a match. In such a method, a sample fingerprint may be compared to each of the images and a similarity indicator may be determined for each of the images. The similarity indicators may be mathematically combined to provide a combined indicator, and the combined indicator may be compared to a threshold. Mathematically combining may be carried out by multiplying a weighting factor to each similarity indicator to provide a weighted score for each image, and then adding the weighted scores to provide the combined indicator.

In another method according to the invention, linked images may be considered as a set of fingerprint images. A first sample fingerprint and a second sample fingerprint may be provided. The first sample may be compared to a first one of the impression images to produce a first similarity indicator, and the second sample fingerprint may be compared to a second one of the impression images to produce a second similarity indicator. The similarity indicators may be mathematically combined to produce a combined-similarity-indicator (“CIS”), and the CIS may be compared to a threshold value. Information may be provided to indicate whether the CIS is less than, greater than or equal to the threshold value, and from this it may be decided whether a match was found between the samples and the set. Mathematically combining the similarity indicators may be carried out by multiplying the first similarity indicator with a weight to provide a weighted first indicator, and multiplying the second similarity indicator with a weight to provide a weighted second indicator. Each weight may be the same or a different value. The weighted first indicator may be added to the weighted second indicator to provide the combined-similarity-indicator.

### BRIEF DESCRIPTION OF THE DRAWINGS

For a fuller understanding of the nature and objects of the invention, reference should be made to the accompanying drawings and the subsequent description. Briefly, the drawings are:

FIG. 1 shows a finger at a stage in the process of rolling the finger in the direction indicated by the arrow in order to generate a rolled impression of the finger;

FIG. 2A shows a finger pressed to a surface so as to flatten an end of the finger against the surface;

FIG. 2B shows a finger pressed to a surface so as to flatten a palm-side of the finger against the surface;

FIG. 2C shows a finger pressed to a surface so as to flatten a left side of the finger against the surface;

FIG. 2D shows a finger pressed to a surface so as to flatten a right side of the finger against the surface;

FIG. 2E shows a finger in a tilted position and pressed to a surface so as to flatten a portion between the palm-side of the finger and the right side of the finger against the surface;

FIG. 2F depicts a database according to the invention;

FIG. 3 depicts a method according to the invention; and

FIG. 4 depicts another method according to the invention.

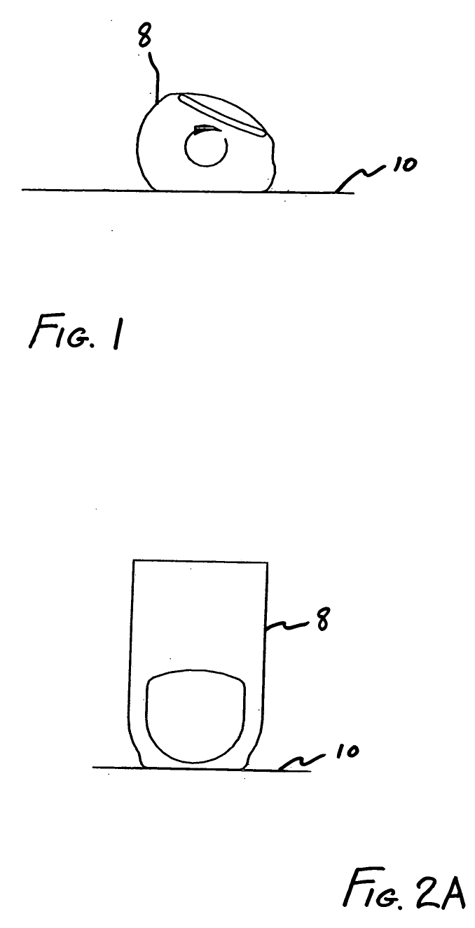

### FURTHER DESCRIPTION OF THE INVENTION

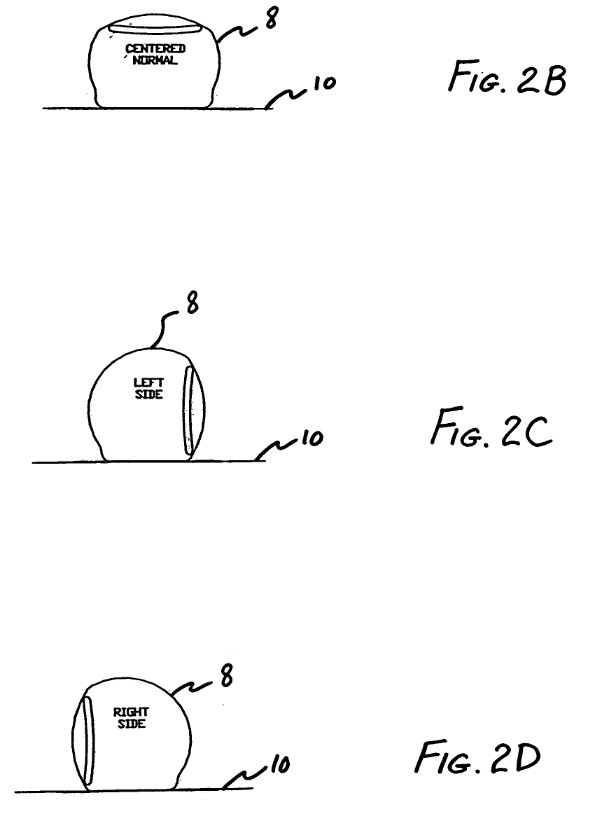

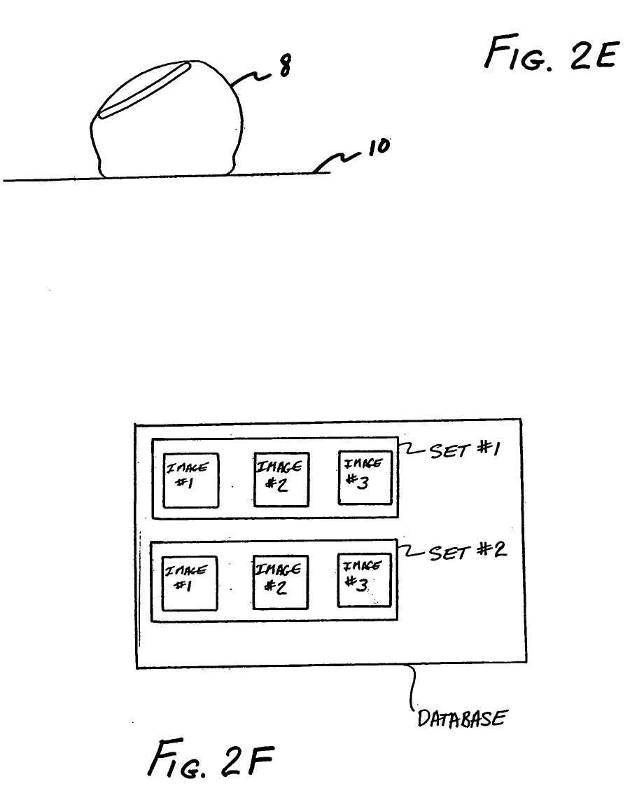

A method according to the invention may gather and store in a database a set of plain impression fingerprint images that represent the skin surface friction ridge detail of one or more fingers. For example, the impression images of a finger 8 may correspond to an end of the finger 8 (see FIG. 2A), a palm-side of the finger 8 (see FIG. 2B), a left side of the finger 8 (see FIG. 2C), or a right side of the finger 8 (see FIG. 2D) pressed against a surface 10. The surface 10 may be an imaging platen of a live-scan ultrasonic imaging device. Further, impression images may correspond to that portion of the friction ridge surface pressed against the surface 10 when the finger 8 is in a tilted orientation (see FIG. 2E). A rolled impression fingerprint image may also be stored in the database. The recorded fingerprint images may be obtained using optical, ultrasonic or conventional paper and ink fingerprinting methods. Images corresponding to more than one finger may be gathered and stored in the database. For example, for an individual, there may be many non-rolled impression images of each of the individual's fingers.

As used herein, the term “multi-image fingerprint” is used to refer to a collection of fingerprint images, each of which shows at least a portion of the friction ridge information of one finger. A multi-image fingerprint may provide sufficient detail to allow comparisons with samples, where the sample was produced by a non-optimum finger orientation. For example, if a finger provided an impression sample at a crime scene, the finger may not have been oriented in the standard palm-down manner when the impression sample was provided. Using a traditional database having fingerprint images, there might not be a match between such a sample and images in the database, even though the sample and the images were provided by the same person.

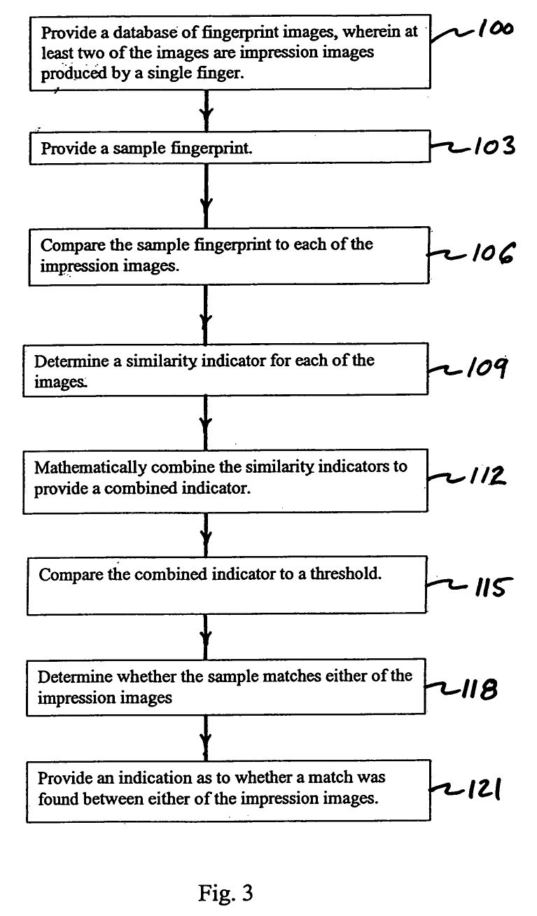

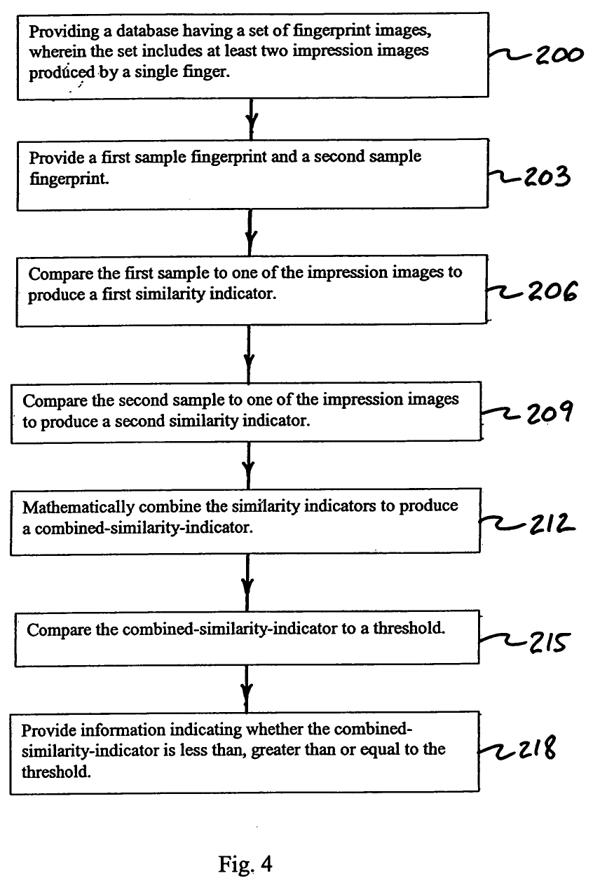

FIG. 3 and FIG. 4 depict methods according to the invention in which a set of fingerprint images may be gathered and stored in a database and that database may be provided 100, 200 for purposes of conducting a search of the stored images. The set of images may include, for example, an impression image of the end of a finger, a palm-side of the finger, a left side of the finger and a right side of the finger. Additional impression images may be included in the set in order to provide additional information about the friction ridge surface that is normally associated with a rolled impression fingerprint. A rolled image of the finger may also be included in the set. The set of images may be linked in the database so as to indicate that the images were taken from the same finger, and are intended to collectively represent the friction ridge surface of the finger. A sample may be provided 103, 203 and one or more of the images in the set may be compared 106, 206, 209 to the sample, which may be latent fingerprints or fingerprints submitted for identification purposes.

The set of impression images may be gathered by pressing a finger against a surface, such as an imaging platen, in a first orientation and obtaining a first image, then in a second orientation and obtaining a second image, then in a third orientation and obtaining a third image, and so on until a desired number of orientations have produced the set of impression images. As such, the impression images will include information that is substantially devoid of the stretching and distorting effects which are often introduced during the process of rolling the fingers. The individual images in the set may be combined using a computer to produce a composite image similar to that customarily obtained in a traditional rolling process, but without the distortions.

In the case of matching a sample against the images stored in the database, the matching process may be carried out against each separate image, carried out against a composite image, or carried out against the rolled impression image. One manner of executing the matching process would be to attempt to find a match based on comparing individual images to a sample fingerprint, and if that does not produce a match, then attempting to find a match based on a set of images, perhaps using a weighted analysis of results from separate images in the set.

For example, if a match between a sample and information in the database is declared when there are at least 16 points of similarity, but no single image in the database produces at least 16 points of similarity with a sample from a crime scene, then a weighted analysis may be undertaken in order to attempt to find a match for the sample. In such a weighted analysis, the sample from the crime scene might be compared 106 to a set of images in the database, and for each image the points of similarity might be calculated to produce 109 a similarity indicator for each image in the set. The similarity indicators may be mathematically combined 112 and compared 115 to a threshold in order to determine whether a match has been found. For example, a weighting factor might be multiplied to each similarity indicator to provide a weighted score for each image. The weighting factor need not be the same value for each image. Then the weighted scores may be added to produce a summed indicator, which would then be compared 115 to a threshold. If the summed indicator is greater than or equal to the threshold, a match may be determined 118 and communicated 121 to law enforcement personnel.

In another weighted analysis according to the invention, more than one sample from a crime scene might be used. For purposes of illustrating such a method, consider a crime scene that produces three sample fingerprints believed to be from the same person. Images of fingerprints in the database may be compared 206, 209 to the three samples, and a similarity indicator may be determined and provided for each of the samples. The similarity indicators may be mathematically combined 212 to produce a combined-similarity indicator. For example, a weight may be provided and mathematically combined with the similarity indicators to produce a weighted score. The weight applied to each similarity indicator need not be the same value. The weighted score may be compared 215 to a threshold, and information may be provided 218 as to whether a match exists between the sample fingerprints and the set. For example, if the weighted score is above a threshold, then a match may be declared.

To illustrate such a method, consider that if the first sample produced 10 points of similarity, and the second sample produced 7 points of similarity, and the third sample produced 6 points of similarity, a weighting factor of 75% might be applied to each in order to provide a weighted similarity point value of 7.5 (10×75%) for the first sample, a weighted similarity point value of 5.25 (7×75%) for the second sample, and a weighted similarity point value of 4.5 (6×75%) for the third sample. The weighted similarity point values may then be added together to provide a weighted score of 17.25 (7.5+5.5+4.5=17.25). If the threshold for the weighted score is 17 points, then a match would be declared 218 since 17.25 is greater than the 17 point threshold requirement.

Provisional patent application No. 60/575,952 describes embodiments of the invention. That provisional patent application is incorporated herein by reference.

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

1. A database of fingerprint images, comprising at least two impression images produced by a single finger, each of the impression images showing a different portion of the friction ridge surface of the finger.

2. The database of claim 1, wherein one of the impression images corresponds to an end of the finger.

3. The database of claim 1, wherein one of the impression images corresponds to a right side of the finger.

4. The database of claim 1, wherein one of the impression images corresponds to a left side of the finger.

5. The database of claim 1, wherein one of the impression images corresponds to a palm-side of the finger.

6. The database of claim 1, wherein one of the impression images corresponds to a portion of the finger presented in a tilted position and pressed to an imaging surface.

7. The database of claim 1, further comprising a rolled impression image corresponding to the finger.

8. A method of comparing a sample fingerprint to a database of fingerprint images, comprising:
providing a database of fingerprint images, wherein at least two of the images are impression images produced by a single finger, each of the impression images showing a different portion of the friction ridge surface of the finger;
providing a sample fingerprint;
comparing the sample fingerprint to each of the impression images;
determining whether the sample matches the impression images; and
providing an indication as to whether a match was found with the impression images.

9. The method of claim 8, wherein determining whether the sample matches includes determining whether the sample is similar enough to the impression images to constitute a match.

10. The method of claim 8, further comprising:
determining a similarity indicator for each of the images;
mathematically combining the similarity indicators to provide a combined indicator; and
comparing the combined indicator to a threshold value.

11. The method of claim 10, wherein mathematically combining includes:
multiplying a weighting factor to each similarity indicator to provide a weighted score for each image; and
adding the weighted scores to provide the combined indicator.

12. A method of comparing a sample fingerprint to a database of fingerprint images, comprising:
providing a database having a set of fingerprint images, wherein the set includes at least two impression images produced by a single finger, each of the impression images showing a different portion of the friction ridge surface of the finger;
providing a first sample fingerprint and a second sample fingerprint;
comparing the first sample to one of the impression images to produce a first similarity indicator;
comparing the second sample to one of the impression images to produce a second similarity indicator;
mathematically combining the similarity indicators to produce a combined-similarity-indicator;
comparing the combined-similarity-indicator to a threshold value; and
providing information indicating whether the combined-similarity-indicator is less than, greater than or equal to the threshold value.

13. The method of claim 12, wherein mathematically combining the similarity indicators includes:
multiplying the first similarity indicator with a weight to provide a weighted first indicator;
multiplying the second similarity indicator with a weight to provide a weighted second indicator;
adding the weighted first indicator to the weighted second indicator to provide the combined-similarity-indicator.
